(19) United States
(12) Patent Application Publication
(10) Pub. No.: US 2025/0390769 A1
(43) Pub. Date: Dec. 25, 2025

(54) PREDICTION APPARATUS, PREDICTION METHOD, AND PROGRAM

(71) Applicant: ANIFIE, INC., Irvine, CA (US)

(72) Inventors: Masao WATANABE, Kanagawa (JP); Yohei IWASAKI, Irvine, CA (US)

(21) Appl. No.: 19/246,246

(22) Filed: Jun. 23, 2025

Related U.S. Application Data
(60) Provisional application No. 63/663,499, filed on Jun. 24, 2024.

(51) Int. Cl. G06N 5/022

(52) U.S. Cl. CPC G06N 5/022

(57) ABSTRACT

A prediction apparatus includes: an acceptance unit that accepts a group of explanatory variables constituted by one or more types of data sets selected from the group consisting of four types of data sets, namely, an actual data set, a simulation result set, an experimental result set, and a calculation result set for a given subject; a prediction unit that acquires a prediction result by performing machine learning prediction processing, using a learning model created by performing learning processing using a group of training data including two or more types of data sets selected from the group consisting of an actual data set, a simulation result set, an experimental result set, and a calculation result set for the given subject, and the accepted group of explanatory variables; and an output unit that outputs the prediction result acquired by the prediction unit.

### CROSS-REFERENCE OF RELATED APPLICATIONS

This application claims the benefit of U.S. Provisional Patent Application No. 63/663,499, filed on Jun. 24, 2024, the entire disclosure of which application is incorporated by reference herein.

### BACKGROUND OF THE INVENTION

### 1. Field of the Invention

The present invention relates to a prediction apparatus or the like that performs machine learning prediction processing, using a learning model acquired using two or more types of data sets (e.g., simulation data and actual machine data) of the same subject and a group of explanatory variables including one or more types of data sets, acquires prediction results, and outputs the prediction results.

### 2. Description of Related Art

Conventionally, there has been a technology called Graph Neural Network (GNN), which is a deep learning model specially designed for processing data with a graph structure (see Non-Patent Document 1).

### PRIOR ART DOCUMENT

### Non-Patent Document

Non-Patent Document 1: “Graph Neural Network (GNN) ni nyumon suru”, [online], [searched Jun. 17, 2024], Internet [URL: https://qiita.com/ymgc3/items/a809d98abde5251bea15]

### SUMMARY OF THE INVENTION

### Problem to be Solved by the Invention

However, in the conventional technology, it is not possible to acquire, using one or more types of data sets selected from the group consisting of four types of data sets, namely, actual data, simulation result data, experimental result data, and calculation result data, one or more types of data sets other than the one or more types of data sets.

### Means for Solving the Problems

A prediction apparatus according to a first aspect of the present invention is a prediction apparatus including: an acceptance unit that accepts a group of explanatory variables constituted by one or more types of data sets selected from the group consisting of four types of data sets, namely, an actual data set, a simulation result set, an experimental result set, and a calculation result set for a given subject; a prediction unit that acquires a prediction result that is a group of objective variables corresponding to the group of explanatory variables by performing machine learning prediction processing, using a learning model created by performing learning processing using a group of training data including two or more types of data sets selected from the group consisting of an actual data set, a simulation result set, an experimental result set, and a calculation result set for the given subject, and the group of explanatory variables accepted by the acceptance unit; and an output unit that outputs the prediction result acquired by the prediction unit.

With this configuration, it is possible to acquire, using one or more types of data sets selected from the group consisting of four types of data sets, namely, actual data, simulation result data, experimental result data, and calculation result data, one or more types of data sets other than the one or more types of data sets.

A prediction apparatus according to a second aspect of the present invention is the prediction apparatus according to the first aspect of the invention, wherein the group of training data includes data sets of the same type acquired at two or more different points in time, the group of explanatory variables accepted by the acceptance unit includes a data set for the given subject at a given point in time, and the prediction unit performs machine learning prediction processing, using the learning model and the group of explanatory variables accepted by the acceptance unit, to acquire a prediction result including a data set that is of the same type as the data set accepted by the acceptance unit, acquired at a point in time different from the given point in time.

With this configuration, it is possible to obtain a prediction result that includes a data set of the same type as the accepted data, acquired at a point in time different from the point in time of the accepted data.

A prediction apparatus according to a third aspect of the present invention is the prediction apparatus according to the first or the second aspect of the invention, wherein the learning model is a graph neural network (GNN).

With this configuration, it is possible to acquire, using one or more types of data sets selected from the group consisting of four types of data sets, namely, actual data, simulation result data, experimental result data, and calculation result data, one or more types of highly accurate data sets other than the one or more types of data sets.

A prediction apparatus according to a third aspect of the present invention is the prediction apparatus according to the third aspect of the invention, further including: a training data management unit in which two or more pieces of training data are stored, the two or more pieces of training data including two or more types of data sets selected from the group consisting of an actual data set, a simulation result set, an experimental result set, and a calculation result set for a given subject; a knowledge management unit in which knowledge graph data is stored, the knowledge graph data containing: two or more pieces of knowledge node information and one or more pieces of knowledge edge information, the two or more pieces of knowledge node information being based on the two or more types of data sets, being two or more pieces of data that constitute graph data to be provided to a learning module that performs machine learning processing, and being two or more pieces of node information, and the one or more pieces of knowledge edge information being one or more pieces of edge information; a graph forming unit that forms graph data to be provided to a learning module, using the knowledge graph data and the training data, for each of the two or more pieces of training data; and a learning unit that provides the two or more pieces of graph data formed by the graph forming unit to the learning module, and executes the learning module to form a learning model, wherein the learning model used by the prediction unit to perform machine learning prediction processing is the learning model formed by the learning unit.

With this configuration, a learning model that is a graph neural network (GNN) can be formed.

A prediction apparatus according to a fifth aspect of the present invention is the prediction apparatus according to the third aspect of the invention, further including a knowledge management unit in which knowledge graph data is stored, the knowledge graph data containing two or more pieces of knowledge node information and one or more pieces of knowledge edge information, the two or more pieces of knowledge node information being based on the two or more types of data sets, being two or more pieces of data that constitute graph data to be provided to a learning module that performs machine learning processing, and being two or more pieces of node information, and the one or more pieces of knowledge edge information being one or more pieces of edge information, wherein the prediction unit includes: a graph forming part that forms graph data, using the group of explanatory variables accepted by the acceptance unit and the two or more pieces of knowledge graph data; and a prediction part that performs machine learning prediction processing, using the graph data formed by the graph forming part and the learning model, to acquire the prediction result.

With this configuration, it is possible to acquire, using one or more types of data sets selected from the group consisting of four types of data sets, namely, actual data, simulation result data, experimental result data, and calculation result data, one or more types of highly accurate data sets other than the one or more types of data sets.

A prediction apparatus according to a sixth aspect of the present invention is the prediction apparatus according to any one of the first to the fifth aspect of the invention, wherein the two or more types of data sets include an actual data set and simulation result set, the group of explanatory variables includes a simulation result set, and the prediction result includes an actual data set.

With this configuration, highly accurate actual data can be acquired using the accepted simulation result data.

A prediction apparatus according to a seventh aspect of the present invention is the prediction apparatus according to any one of the first to the sixth aspect of the invention, wherein the two or more types of data sets include a simulation result set, and the simulation result set is constituted by one or more results of a finite element analysis.

With this configuration, highly accurate actual data can be acquired using simulation result data that is the result of the accepted finite element analysis.

### Advantageous Effect of the Invention

With the prediction apparatus according to the present invention, it is possible to acquire, using one or more types of data sets selected from the group consisting of four types of data sets, namely, actual data, simulation result data, experimental result data, and calculation result data, one or more types of data sets other than the one or more types of data sets.

### BRIEF DESCRIPTION OF THE DRAWINGS

FIG. 1 is a conceptual diagram of a prediction system A according to a first embodiment.

FIG. 2 is a block diagram of the prediction system A according to the same.

FIG. 3 is a flowchart illustrating examples of operations of a prediction apparatus 1 according to the same.

FIG. 4 is a flowchart illustrating an example of prediction processing according to the same.

FIG. 5 is a flowchart illustrating an example of graph formation processing according to the same.

FIG. 6 is a flowchart illustrating an example of knowledge graph search processing according to the same.

FIG. 7 is a flowchart illustrating an example of match judgment processing according to the same.

FIG. 8 is a flowchart illustrating an example of similarity judgment processing according to the same.

FIG. 9 is a flowchart illustrating an example of inference processing according to the same.

FIG. 10 is a flowchart illustrating an example of node connecting processing according to the same.

FIG. 11 is a flowchart illustrating an example of learning processing according to the same.

FIG. 12 is a diagram showing an example of knowledge data according to the same.

FIG. 13 is a diagram showing an example of training data according to the same.

FIG. 14 is a diagram showing an example of graph data according to the same.

FIG. 15 is a diagram showing an example of graph data according to the same.

FIG. 16 is a diagram showing an example of graph data according to the same.

FIG. 17 is a diagram showing an example of graph data according to the same.

FIG. 18 is a block diagram of a computer system according to the same.

### DETAILED DESCRIPTION OF THE INVENTION

Hereinafter, embodiments of a prediction apparatus and so on will be described with reference to the drawings. Note that, in the embodiments, components with the same reference numerals perform similar operations, and therefore repeated descriptions may be omitted.

### First Embodiment

The present embodiment describes a prediction apparatus that performs machine learning prediction processing, using a learning model created through learning processing using a group of training data, which is two or more types of data sets (e.g., actual data, simulation results, experimental results, and calculation results) of the same subject, and a group of explanatory variables including one or more types of data sets, acquires prediction results, and outputs the prediction results.

The group of training data here may include the same type of data set of the same subject acquired at two or more different points in time. It is preferable that the learning model here is a graph neural network (GNN). It is preferable that the two or more types of data sets here are actual data and simulation results, the group of explanatory variables is simulation results, and the prediction results are actual data.

In this specification, the association between information X and information Y indicates that information Y can be derived from information X, or information X can be derived from information Y, and there is no restriction on the method of association. For example, information X and information Y may be linked with each other or present in the same buffer, information X may be included in information Y, or information Y may be included in information X.

Furthermore, in this specification, selecting or determining information Z means acquiring information Z, acquiring a pointer to information Z, acquiring the ID of information Z, setting a flag for information Z, etc., and it is sufficient if information Z is accessible.

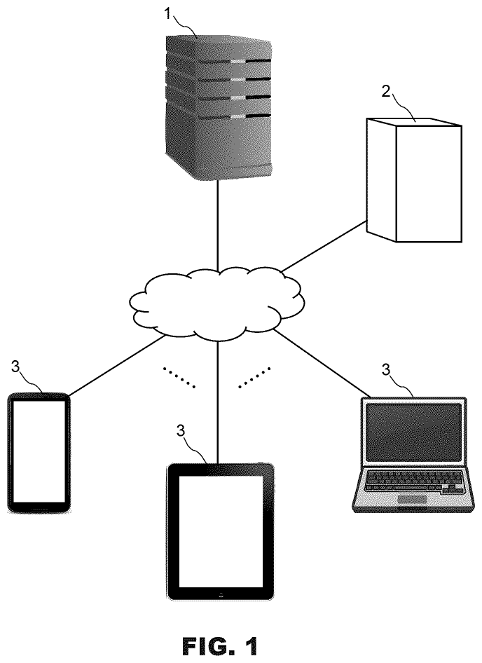

FIG. 1 is a conceptual diagram of a prediction system A according to the present embodiment. The prediction system A includes a prediction apparatus 1 and a learning apparatus 2. Note that if the prediction apparatus 1 has a learning function, the learning apparatus 2 is not required.

The prediction apparatus 1 is an apparatus that acquires prediction results. The prediction apparatus 1 is, for example, a server, but may also be a terminal. The prediction apparatus 1 is, for example, a cloud server or an ASP server, but there is no restriction on the type thereof. The prediction apparatus 1 is, for example, a smartphone, a tablet terminal, a personal computer, or the like, but there is no restriction on the type thereof.

The learning apparatus 2 is an apparatus that forms a learning model, which will be described later. The learning apparatus 2 is, for example, a server, but may also be a terminal. The learning apparatus 2 is, for example, a cloud server or an ASP server, but there is no restriction on the type thereof. The learning apparatus 2 may be, for example, a smartphone, a tablet terminal, a personal computer, or the like, but there is no restriction on the type thereof.

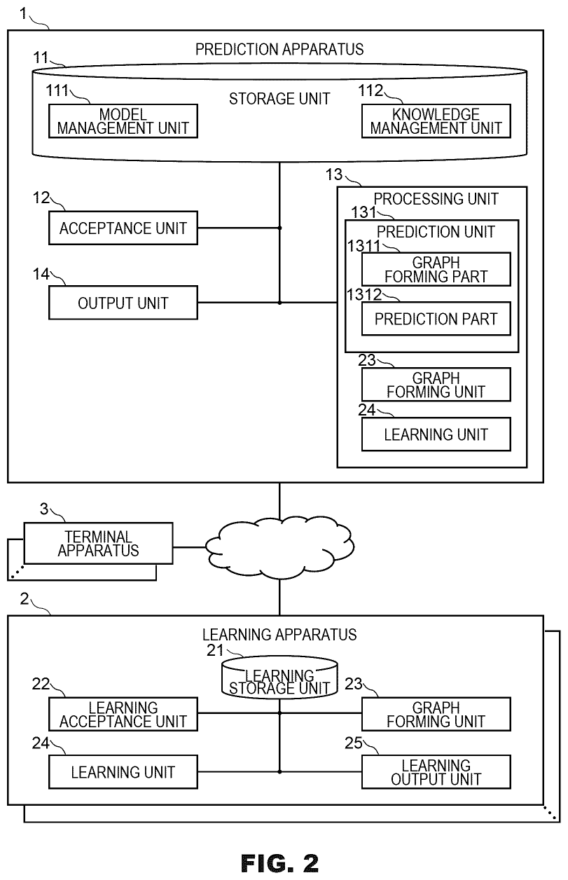

FIG. 2 is a block diagram of the prediction system A according to the present embodiment. The prediction apparatus 1 includes a storage unit 11, an acceptance unit 12, a processing unit 13, and an output unit 14. The storage unit 11 includes a model management unit 111 and a knowledge management unit 112. The processing unit 13 includes a prediction unit 131. The processing unit 13 may include a graph forming unit 23 and a learning unit 24. The prediction unit 131 includes a graph forming part 1311 and a prediction part 1312.

The learning apparatus 2 includes a learning storage unit 21, a learning acceptance unit 22, a graph forming unit 23, a learning unit 24, and a learning output unit 25.

The prediction apparatus 1 and the learning apparatus 2 may be integrated into one apparatus, or may be separate apparatuses. If they are separate apparatuses, it is preferable that the two apparatuses are capable of communicating with each other over a network such as the Internet.

The storage unit 11 included in the prediction apparatus 1 stores various types of information. Examples of the various types of information include learning models described later.

The model management unit 111 stores one or more learning models. Each learning model is information formed through machine learning processing, and is information used in machine learning prediction processing. It is preferable that the learning models are models acquired by the learning unit 24 or the learning apparatus 2. The learning model may be referred to as a learner, a classifier, a classification model, or the like. It is preferable that the machine learning algorithm is deep learning, but may be random forest, decision tree, or the like, and there is no restriction. Also, for machine learning, various machine learning functions and various existing libraries, such as the TensorFlow (registered trademark) library, the random forest module of the R language, and fastText can be used.

Each learning model here is a model created by performing learning processing, using a group of training data including two or more types of data sets for the given subject selected from the group consisting of an actual data set, a simulation result set, an experimental result set, and a calculation result set. It is preferable that each learning model is a graph neural network (GNN), but it may be another data structure such as a neural network.

Each learning model here is, for example, a model used to acquire an actual data set, using one or more types of data set selected from the group consisting of a simulation result set, an experimental result set, and a calculation result set.

Each learning model here is, for example, a model used to acquire an experimental result set, using one or two types of data sets selected from the group consisting of a simulation result set and a calculation result set.

Each learning model here is, for example, a model used to acquire, using a data set including a data set of a given subject at a given point in time, a data set of the same type as the data set at the given point in time, acquired at a point in time different from the given point in time.

The subject is the subject of prediction. Examples of subjects include physical simulations such as astronomy, meteorology, optimal design of materials, optimal structural design of buildings, and fluid design, chemical simulations such as optimization of contaminated water treatment and polymer design, biological simulations represented by protein behavior, social simulations such as epidemics, economic models, traffic flow, and human flow dynamics, high-dimensional image simulations, social media analysis and marketing analysis, demand forecasts based on modeling of product characteristics and functions, optimization of production lines by modeling of manufacturing processes, environmental impact assessments, and optimization of energy supply/demand for power generation/consumption. However, there is no restriction on the subject.

An actual data set is constituted by one or more pieces of actual data. Actual data is real data. Examples of actual data include data from an actual machine and clinical trial data from human subjects. Actual data is data collected directly from the real world. Actual data is also called observation data and may also be field data, operational data, or the like. Specifically, actual data may be, for example, weather observations, sensor logs, economic statistics, user behavior data, image data, video data, audio data, or the like.

A simulation result set is constituted by one or more simulation results for a subject. The simulation results are information indicating the results of a simulation. It is preferable that the simulation results are the results of a finite element analysis. Simulation results are pieces of data generated using a computer model to mimic real-world events. Examples of the simulation results include results of physical simulations, meteorological simulations, and economic models.

An experimental result set is constituted by one or more experimental results for a subject. Experimental results are pieces of data on the results acquired when an experiment was conducted in an experimental environment, not a real-world environment. Experimental results are pieces of data acquired from experiments conducted under specific conditions in a controlled environment. Experimental results are, for example, pieces of data acquired from scientific experiments, engineering tests, or the like.

A calculation result set is constituted by one or more calculation results. The calculation results are pieces of data acquired by performing calculation on a subject.

The knowledge management unit 112 stores knowledge data. Knowledge data is data that is based on one or more types of data sets. Knowledge data is information for forming graph data to be used in machine learning prediction processing or machine learning processing.

The knowledge data is, for example, graph data. Such graph data is called knowledge graph data. The knowledge graph data includes two or more pieces of knowledge node information and one or more pieces of knowledge edge information. The knowledge node information is node information used to form knowledge graph data. The knowledge edge information is edge information used to form knowledge graph data.

Node information is information about the nodes that constitute graph data. The node information includes, for example, character strings and numerical values. The node information may include multimodal data such as image data, video data, and audio data in addition to character strings and numerical values. The character strings and numerical values are explanatory variables or objective variables. The character strings and the numerical values may, for example, include the attribute name of the subject or the attribute value of the subject. The node information includes, for example, type information. The type information is information that indicates a data type. The type information is, for example, “actual data set”, “simulation result set”, “experimental result set”, or “calculation result set”. The node information is associated with, for example, a node identifier. The node identifier is information that identifies a node. The node identifier is the ID of a node or the name of a node.

Edge information is information that defines a relationship between two or more nodes. The edge information is information about the edges that constitute graph data. The edge information contains, for example, the node identifiers of two nodes that are connected by an edge. Note that the edges here are usually directed edges, but may be undirected edges.

The acceptance unit 12 accepts a group of explanatory variables. The acceptance unit 12 may accept a prediction instruction that contains a group of explanatory variables. The acceptance unit 12 may accept a learning instruction.

The prediction instruction is an instruction to perform prediction processing, which will be described later, to acquire prediction results. The learning instruction is an instruction to perform learning processing, which will be described later, using two or more pieces of training data.

The group of explanatory variables is a set of data used in prediction processing, which will be described later. The group of explanatory variables is one or more types of data sets selected from the group consisting of four types of data sets, namely, an actual data set, a simulation result set, an experimental result set, and a calculation result set for a given subject. The acceptance unit 12 accepts a group of explanatory variables, which are digital signals.

Here, “acceptance” is, for example, reception of information transmitted via a wired or wireless communication network, but may be a concept that encompasses acceptance of information input from an input device such as a keyboard, a mouse, or a touch panel, or acceptance of information read out from a recording medium such as an optical disk, a magnetic disk, or a semiconductor memory.

The processing unit 13 performs various kinds of processing. Examples of the various types of processing include the processing performed by the prediction unit 131, the processing performed by the graph forming unit 23, which will be described later, and the processing performed by the learning unit 24, which will be described later. The processing unit 13 performs processing on digital signals.

The prediction unit 131 performs machine learning prediction processing, using a learning model in the model management unit 111 and the group of explanatory variables accepted by the acceptance unit 12, to acquire prediction results, which are a group of objective variables corresponding to the group of explanatory variables.

For example, the prediction unit 131 performs machine learning prediction processing, using a learning model in the model management unit 111 and the group of explanatory variables accepted by the acceptance unit 12, to acquire prediction results that include a data set of the same type as the data set accepted by the acceptance unit 12, acquired at a point in time different from the given point in time.

It is preferable that the data set used to form a learning model includes actual data and simulation result data, the group of explanatory variables accepted by the acceptance unit 12 includes a simulation result set, and the prediction result is an actual data set.

It is preferable that the group of explanatory variables accepted by the acceptance unit 12 includes one or more types of data sets selected from the group consisting of a simulation result set, an experimental result set, and a calculation result set, and the prediction result is an actual data set.

For example, the group of explanatory variables accepted by the acceptance unit 12 includes one or two types of data sets selected from the group consisting of a simulation result set and a calculation result set, and the prediction results are an experimental result set.

For example, the group of explanatory variables accepted by the acceptance unit 12 includes one or two types of data set selected from the group consisting of an experimental result set and a calculation result set, and the prediction results are a simulation result set.

It is preferable that the machine learning algorithm is deep learning using a GNN, but it may be another algorithm, such as deep learning using a neural network, random forest, or decision tree.

The graph forming part 1311 acquires graph data, using the group of explanatory variables accepted by the acceptance unit 12 and the knowledge data in the knowledge management unit 112. The processing by the graph forming part 1311 will be described in detail later.

It is preferable that the prediction part 1312 performs machine learning prediction processing, using the graph data formed by the graph forming part 1311 and a GNN learning model, to acquire prediction results. Examples of the means by which the prediction part 1312 performs prediction processing may include minimizing the error between the predicted value and the actual value, using a loss function such as mean square error, mean absolute error, cross-entropy loss, or hinge loss, or evaluating the discrepancy between the model's predicted probability distribution and the actual data distribution, using negative log-likelihood, Kullback-Leibler Divergence, Pearson's Chi-Squared, Jensen-Shannon Divergence, or the like.

The prediction part 1312 may, for example, form a vector from the group of explanatory variables accepted by the acceptance unit 12, and perform machine learning prediction processing, using the vector and a learning model, to acquire prediction results. The vector in this case is, for example, a vector whose elements are the explanatory variables that constitute the group of explanatory variables. The learning model in such cases is a normal neural network or a convolutional neural network (CNN). When using a learning model of a normal neural network or a convolutional neural network, the graph forming part 1311 is not required.

The output unit 14 outputs the prediction results acquired by the prediction unit 131. The output unit 14 may output a part of the information acquired by the prediction unit 131. Note that the part of the information is also prediction results. The processing unit 13 outputs prediction results, which are digital signals.

Here, “output” is a concept that encompasses displaying on a display screen, projection using a projector, printing by a printer, the output of a sound, transmission to an external apparatus, accumulation on a recording medium, delivery of a processing result to another processing apparatus or another program, and the like.

The learning storage unit 21 included in the learning apparatus 2 stores various types of information. Examples of the various types of information include a group of training data and knowledge data.

The group of training data contains two or more pieces of training data. The training data includes two or more types of data sets selected from the group consisting of an actual data set, a simulation result set, an experimental result set, and a calculation result set for one subject.

The knowledge data is the same information as the knowledge data in the knowledge management unit 112. The knowledge data is typically knowledge graph data.

The learning acceptance unit 22 accepts various types of instructions and information. Examples of the various types of instructions and information include a learning instruction. The learning instruction is an instruction to perform learning processing. The learning acceptance unit 22 accepts various types of instructions and information, which are digital signals.

Any input means, such as a touch panel, a keyboard, a mouse, a menu screen, or the like, may be employed to input the various types of instructions and information.

The graph forming unit 23 performs the same processing as the graph forming part 1311. The graph forming unit 23 forms graph data for each of the two or more pieces of training data.

The learning unit 24 performs machine learning processing, using the group of training data in the learning storage unit 21, to form a learning model. An example of such learning processing is the formation of a GNN, which will be described later. However, the learning unit 24 may form a learning model such as a neural network or a decision tree.

It is preferable that the learning unit 24 uses two or more pieces of graph data formed by the graph forming unit 23 for each of the two or more pieces of training data to perform machine learning processing to form a learning model. Algorithms used by the learning unit 24 to form a learning model include an algorithm that generates a learning model by expressing features using spectral or spatial graph convolution, graph autoencoder, message passing, or graph embedding that combines these with an attention mechanism.

The learning unit 24 may form a vector for each of two or more pieces of training data, provide the two or more vectors to a learning module that performs machine learning processing, and execute the learning module to form a learning model. Such a learning model is, for example, a typical neural network, or CNN.

The learning output unit 25 outputs the learning model formed by the learning unit 24. The output here is typically accumulation on a recording medium. The recording medium may be the learning storage unit 21 or a recording medium in an external apparatus. The learning output unit 25 outputs the learning model, which is constituted by digital signals.

It is preferable that the storage unit 11, the model management unit 111, the knowledge management unit 112, and the learning storage unit 21 are non-volatile recording media, but they may also be realized as volatile recording media.

There is no limitation on the process in which information is stored in the storage unit 11 or the like. For example, information may be stored in the storage unit 11 or the like via a recording medium, or information transmitted via a communication line or the like may be stored in the storage unit 11 or the like, or information input via an input device may be stored in the storage unit 11 or the like.

The acceptance unit 12 and the learning acceptance unit 22 can be realized using, for example, a device driver for the input means such as a touch panel or a keyboard, or control software or the like for controlling the menu screen. The acceptance unit 12 may be realized using a wireless or wired communication means.

The processing unit 13, the prediction unit 131, the graph forming part 1311, the prediction part 1312, the graph forming unit 23, the learning unit 24, and the learning output unit 25 can typically be realized using a processor, a memory, and so on. The processing procedures performed by the processing unit 13 and so on are typically realized using software, and the software is recorded on a recording medium such as a ROM. However, such processing procedures may be realized using hardware (a dedicated circuit). Note that the processor may be a CPU, an MPU, a GPU, or the like, and there is no limitation on the type thereof.

The output unit 14 can be realized using, for example, the driver software of the output device such as a display or a speaker, the driver software of the output device and the output device, or the like. The output unit 14 and so on may be realized using a wireless or wired communication means.

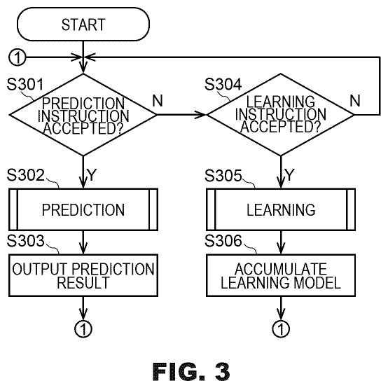

Next, examples of operations of the prediction apparatus 1 will be described with reference to the flowchart in FIG. 3.

(Step S301) The acceptance unit 12 judges whether or not a prediction instruction has been accepted. If a prediction instruction has been accepted, processing proceeds to step S302, and if a prediction instruction has not been accepted, processing proceeds to step S304. Note that the prediction instruction typically contains a group of explanatory variables or a link to a group of explanatory variables.

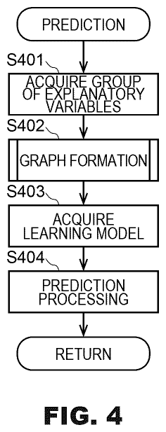

(Step S302) The prediction unit 131 acquires a group of explanatory variables from the prediction instruction, and performs machine learning prediction processing, using the group of explanatory variables and the learning model in the model management unit 111, to acquire prediction results. An example of prediction processing will be described with reference to the flowchart in FIG. 4.

(Step S303) The output unit 14 outputs all or a portion of the prediction results acquired in step S302. Processing returns to step S301. Note that the prediction results acquired in step S302 are, for example, graph data. For example, the output unit 14 may extract one or more pairs of an attribute name and an attribute value from the prediction results, which are the graph data acquired in step S302, and output the one or more pairs of information (attribute names and attribute values).

(Step S304) The acceptance unit 12 judges whether or not a learning instruction has been accepted. If a learning instruction has been accepted, processing proceeds to step S305, and if a learning instruction has not been accepted, processing returns to step S301.

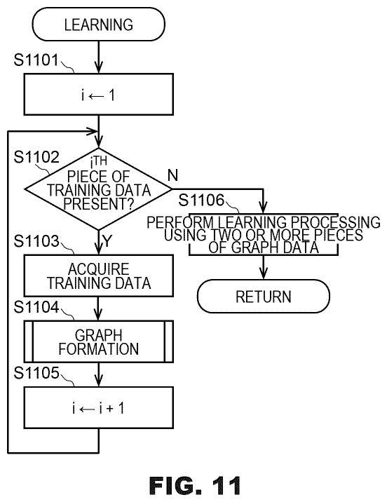

(Step S305) The learning unit 24 performs learning processing. An example of learning processing will be described with reference to the flowchart in FIG. 11.

(Step S306) The learning output unit 25 accumulates the learning model acquired in step S305. Processing returns to step S301. For example, the learning output unit 25 accumulates the learning model in the model management unit 111.

In the flowchart in FIG. 3, processing is terminated when power is turned off or an interruption is made to terminate the processing.

Next, an example of prediction processing in step S302 will be described with reference to the flowchart in FIG. 4.

(Step S401) The graph forming part 1311 acquires a group of explanatory variables that are based on the prediction instruction. The group of explanatory variables based on the prediction instruction is, for example, a group of explanatory variables contained in the prediction instruction, or a group of explanatory variables that can be acquired from a link (e.g., a URL) contained in the prediction instruction.

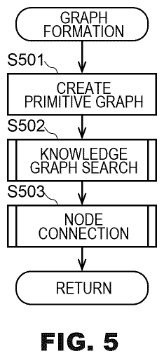

(Step S402) The graph forming part 1311 forms graph data, using the group of explanatory variables. An example of such graph forming processing will be described with reference to the flowchart in FIG. 5.

(Step S403) The prediction part 1312 acquires a learning model in the model management unit 111. The learning model here is a GNN.

(Step S404) The prediction part 1312 provides the graph data acquired in step S402 and the learning model acquired in step S403 to a prediction module that performs machine learning prediction processing, and executes the prediction module to acquire prediction results. Processing returns to higher level processing.

Next, an example of the graph forming processing in step S402 will be described with reference to the flowchart in FIG. 5.

(Step S501) The graph forming part 1311 creates one or more primitive graphs from the group of explanatory variables. The primitive graphs are pieces of primitive graph data. Each primitive graph has two nodes and an edge connecting the nodes. Each primitive graph here has, for example, a first node, a second node, and an edge. The first node has node information that contains an attribute name and type information. The second node has node information that contains an attribute value and type information. The edge has edge information that contains a directed graph from the second node to the first node.

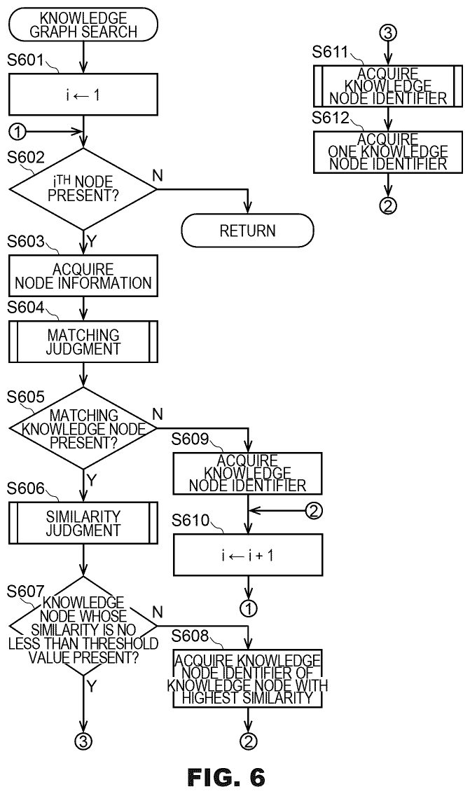

(Step S502) The graph forming part 1311 performs knowledge graph search processing, using the one or more primitive graphs acquired in step S501. An example of knowledge graph search processing will be described with reference to the flowchart in FIG. 6.

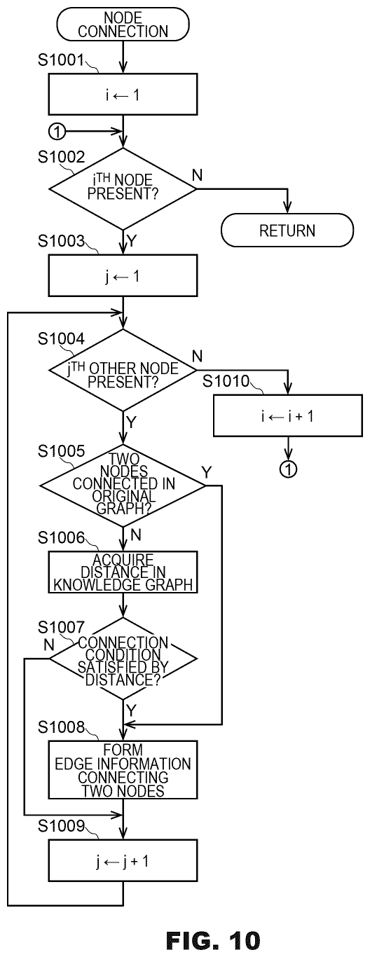

(Step S503) The graph forming part 1311 performs processing to connect the nodes acquired in step S502 to acquire graph data. Processing returns to higher level processing. An example of such node connecting processing will be described with reference to the flowchart in FIG. 10.

Next, an example of the knowledge graph search processing in step S502 will be described with reference to the flowchart in FIG. 6.

(Step S601) The graph forming part 1311 substitutes 1 for a counter i.

(Step S602) The graph forming part 1311 judges whether or not an i^{th} node is present in the one or more acquired primitive graphs. If the i^{th} node is present, processing proceeds to step S603, and otherwise processing returns to higher level processing.

(Step S603) The graph forming part 1311 acquires node information of the i^{th} node.

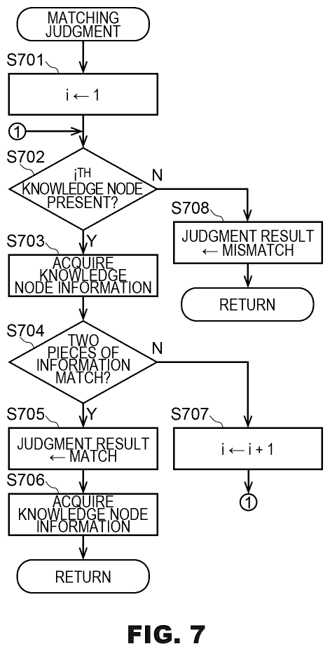

(Step S604) The graph forming part 1311 searches the knowledge graph data for a node that matches the i^{th} node, using the node information of the i^{th} node. An example of such match judgment processing will be described with reference to the flowchart in FIG. 7.

(Step S605) The graph forming part 1311 judges whether or not a matching knowledge node is present in step S604. If a matching knowledge node is present, processing proceeds to step S609, and otherwise processing proceeds to step S606.

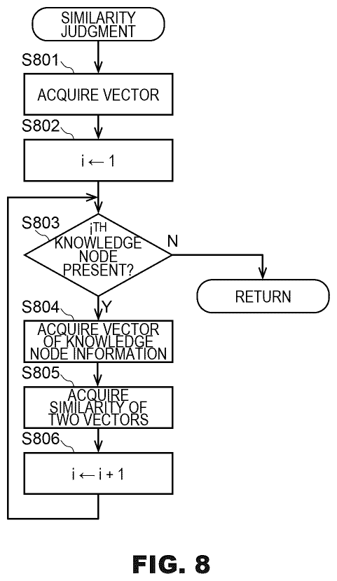

(Step S606) The graph forming part 1311 searches the knowledge graph data for a node that is similar to the i^{th} node, using the node information of the i^{th} node. An example of such similarity judgment processing will be described with reference to the flowchart in FIG. 8.

(Step S607) The graph forming part 1311 judges whether or not a knowledge node whose similarity is greater than or equal to a threshold value is present. If a knowledge node whose similarity is greater than or equal to the threshold value is present, processing proceeds to step S608, and otherwise processing proceeds to step S611.

(Step S608) The graph forming part 1311 acquires the knowledge node identifier of the knowledge node with the highest similarity, associates the knowledge node information thereof with the node information acquired in step S603, and temporarily accumulates them in a buffer (not shown).

(Step S609) The graph forming part 1311 acquires the knowledge node identifier of the matching knowledge node.

(Step S610) The graph forming part 1311 increments the counter i by 1. Processing returns to step S602.

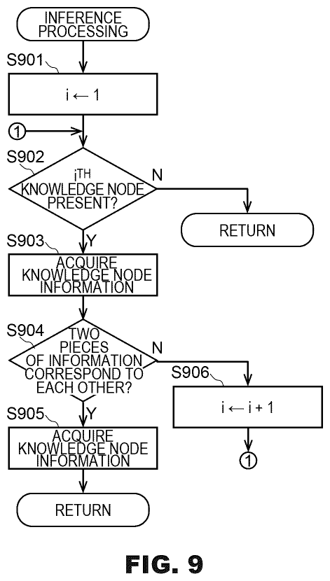

(Step S611) The graph forming part 1311 performs inference processing. An example of inference processing will be described with reference to the flowchart in FIG. 9.

(Step S612) The graph forming part 1311 acquires the knowledge node identifier of one knowledge node.

Next, an example of the match judgment processing in step S604 will be described with reference to the flowchart in FIG. 7.

(Step S701) The graph forming part 1311 substitutes 1 for a counter i.

(Step S702) The graph forming part 1311 judges whether or not an i^{th} knowledge node is present in the knowledge management unit 112. If the i^{th} knowledge node is present, processing proceeds to step S703, and otherwise processing proceeds to step S708.

Here, it is preferable that the graph forming part 1311 does not adopt the already mapped knowledge node as the i^{th} knowledge node. The already mapped knowledge node is the node corresponding to the knowledge node information temporarily accumulated in a buffer (not shown) in step S706.

(Step S703) The graph forming part 1311 acquires the knowledge node information of the i^{th} knowledge node from the knowledge management unit 112.

(Step S704) the graph forming part 1311 judges whether or not the two pieces of node information match. If they match, processing proceeds to step S705, and otherwise processing proceeds to step S707. Note that the two pieces of node information here are the node information acquired in step S603 and the node information acquired in step S703.

(Step S705) The graph forming part 1311 substitutes “match” for the variable “judgment result”.

(Step S706) The graph forming part 1311 acquires the knowledge node information of the i^{th} knowledge node, associates the knowledge node information with the node information acquired in step S603, and temporarily accumulates them in a buffer (not shown). Processing returns to higher level processing.

(Step S707) The graph forming part 1311 increments the counter i by 1. Processing returns to step S702.

(Step S708) The graph forming part 1311 substitutes “mismatch” for the variable “judgment result”. Processing returns to higher level processing.

Next, an example of the similarity judgment processing in step S606 will be described with reference to the flowchart in FIG. 8.

(Step S801) The graph forming part 1311 acquires the vector of node information. For example, the graph forming part 1311 uses a technique such as Word2Vec to acquire the vector of node information.

(Step S802) The graph forming part 1311 substitutes 1 for a counter i.

(Step S803) The graph forming part 1311 judges whether or not an i^{th} knowledge node is present in the knowledge management unit 112. If the i^{th} knowledge node is present, processing proceeds to step S804, and otherwise processing returns to higher level processing.

Here, it is preferable that the graph forming part 1311 does not adopt the already mapped knowledge node as the i^{th} knowledge node.

(Step S804) The graph forming part 1311 acquires the i^{th} piece knowledge node information from the knowledge management unit 112. The graph forming part 1311 acquires the vector of the knowledge node information.

(Step S805) The graph forming part 1311 acquires the similarity between the two vectors, and associates the similarity with the i^{th} knowledge node.

(Step S806) The graph forming part 1311 increments the counter i by 1. Return to step S803.

Next, an example of the inference processing in step S611 will be described with reference to the flowchart in FIG. 9.

(Step S901) The graph forming part 1311 substitutes 1 for a counter i.

(Step S902) The graph forming part 1311 judges whether or not the i^{th} knowledge node is present in the knowledge management unit 112. If the i^{th} knowledge node is present, processing proceeds to step S903, and otherwise processing returns to higher level processing.

Here, it is preferable that the graph forming part 1311 does not adopt the already mapped knowledge node as the i^{th} knowledge node.

(Step S903) The graph forming part 1311 acquires the i^{th} piece of knowledge node information from the knowledge management unit 112.

(Step S904) The graph forming part 1311 judges whether or not the two pieces of node information correspond to each other. If the two pieces of node information correspond to each other, processing proceeds to step S905, and if the two pieces of node information do not correspond to each other, processing proceeds to step S906.

For example, the graph forming part 1311 acquires the superordinate term of each of the two pieces of node information, and judges whether or not the two terms match and whether or not the similarity of the vectors acquired from the two terms is greater than or equal to a threshold value.

For example, the graph forming part 1311 forms a prompt including two pieces of node information and asking whether or not the two pieces of node information have the same meaning, and provides the prompt to a generative AI to acquire an answer from the generative AI.

(Step S905) The graph forming part 1311 acquires the knowledge node information of the i^{th} knowledge node, associates the knowledge node information with the node information acquired in step S603, and temporarily accumulates them in a buffer (not shown).

(Step S906) The graph forming part 1311 increments the counter i by 1. Processing returns to step S902.

Next, an example of the node connecting processing in step S503 will be described with reference to the flowchart in FIG. 10.

(Step S1001) The graph forming part 1311 substitutes 1 for a counter i.

(Step S1002) The graph forming part 1311 judges whether or not the i^{th} node is present in the buffer (not shown) in which knowledge node information is temporarily accumulated. If the i^{th} node is present, processing proceeds to step S1003, and otherwise processing returns to higher level processing.

(Step S1003) The graph forming part 1311 substitutes 1 for a counter j.

(Step S1004) The graph forming part 1311 judges whether or not a j^{th} other node is present in a buffer (not shown). If the j^{th} other node is present, processing proceeds to step S1005, and otherwise processing proceeds to step S1010.

(Step S1005) The graph forming part 1311 judges whether or not the two nodes are connected in the original graph. If the two nodes are connected, processing proceeds to step S1008, and otherwise processing proceeds to step S1006.

(Step S1006) The graph forming part 1311 acquires the distance between the two nodes in the knowledge graph. The distance between the two nodes is calculated, for example, by calculating the the minimum number of edges between the two nodes in a knowledge graph, the sum of the weights of the shortest edges between the two nodes in the knowledge graph, or by calculating cosine similarity between node vectors acquired by, for example, applying convolution over information from neighboring nodes.

(Step S1007) The graph forming part 1311 judges whether or not the distance acquired in step S1006 satisfies a connection condition. If the connection condition is satisfied, processing proceeds to step S1008, and otherwise processing proceeds to step S1009. Note that the connection condition is a condition for connecting two nodes to each other. The connection condition is, for example, that the distance is not greater than a threshold value, or less than a threshold value.

(Step S1008) The graph forming part 1311 forms edge information of an edge that connects nodes (two nodes) that are nodes corresponding to the two nodes in the knowledge graph and constitute a primitive graph, and temporarily accumulates the edge information in a buffer (not shown).

(Step S1009) The graph forming part 1311 increments the counter j by 1. Processing returns to step S1004.

(Step S1010) The graph forming part 1311 increments the counter i by 1. Processing returns to step S1002.

Next, an example of the learning processing in step S305 will be described with reference to the flowchart in FIG. 11.

(Step S1101) The learning unit 24 substitutes 1 for a counter i.

(Step S1102) The graph forming part 1311 judges whether or not the i^{th} piece of training data is present. If the i^{th} piece of training data is present, processing proceeds to step S1103, and otherwise processing proceeds to step S1106.

(Step S1103) The graph forming part 1311 acquires the i^{th} piece of training data from the storage unit 11.

(Step S1104) The graph forming part 1311 converts the i^{th} piece of training data into graph data. An example of such graph forming processing has been described with reference to the flowchart in FIG. 5.

(Step S1105) The learning unit 24 increments the counter i by 1. Processing returns to step S1102.

(Step S1106) The learning unit 24 performs learning processing, using two or more pieces of graph data, to acquire a learning model. Processing returns to higher level processing.

Next, examples of the operations of the learning apparatus 2 will be described. Examples of the operations of the learning apparatus 2 correspond to the operations from S304 to S306 shown in FIG. 3 and the operations shown in FIG. 11.

Hereinafter, specific examples of the operations of the prediction system A according to the present embodiment will be described. The subject here is, for example, contaminated water treatment. Two specific examples will be described. Specific Example 1 is learning processing performed by the learning apparatus 2. Specific Example 2 is prediction processing performed by the prediction apparatus 1.

### Specific Example 1

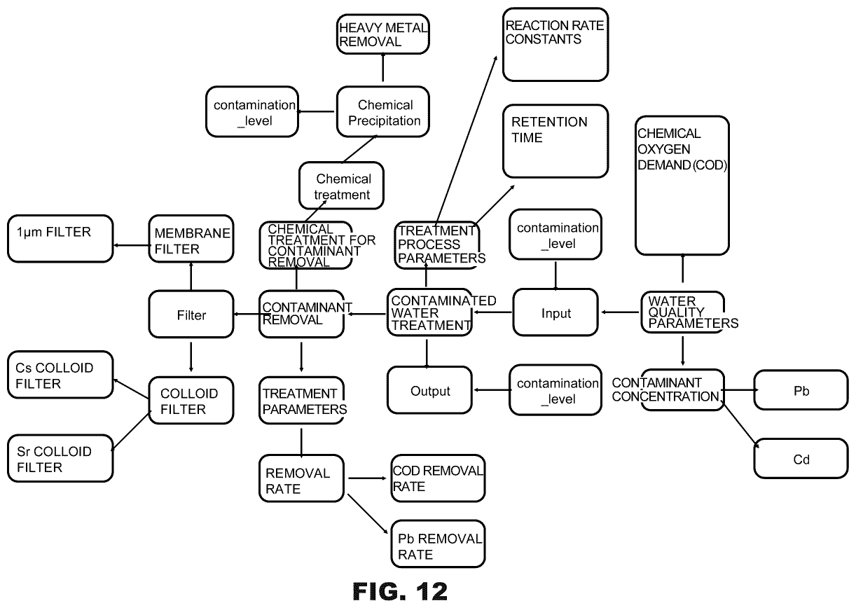

Now, it is assumed that the learning storage unit 21 of the learning apparatus 2 stores the knowledge data shown in FIG. 12.

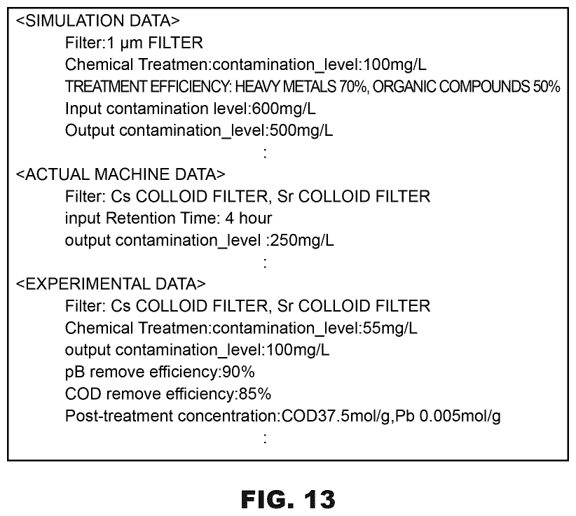

It is also assumed that the learning storage unit 21 stores a large number of pieces of training data including the training data shown in FIG. 13. It is assumed that the training data here is a set of simulation data, actual machine data, and experimental data for contaminated water treatment.

Simulation data for contaminated water treatment is data used to virtually reproduce the process of contaminated water treatment. Examples of such simulation data include data regarding the types and concentration levels of specific contaminants (such as radioactive substances, heavy metals, and organic compounds) contained in the contaminated water, basic information regarding the water quality of the contaminated water, such as pH, temperature, dissolved oxygen levels, and conductivity, parameters for evaluating the effectiveness of various treatment technologies (e.g., reverse osmosis, activated carbon adsorption, biological treatment, and chemical precipitation), data regarding the flow rate of water passing through the treatment system, the time required for treatment, or data on temporal changes in the water flow rate.

Actual machine data in contaminated water treatment refers to actual measurement data obtained from the actual treatment system and apparatus. Examples of such actual machine data may include treatment system operating data such as flow rate, treatment time, pressure, and temperature, water quality data at the inlet and outlet, apparatus performance data such as treatment efficiency, energy consumption, and maintenance data, and environmental data such as ambient weather conditions and discharge data.

Experimental data in contaminated water treatment is data obtained from experiments conducted in laboratories or pilot plants. Examples of such experimental data include water quality characteristic data such as initial contaminant concentration and water quality parameters, treatment condition data such as treatment method and operating conditions, treatment efficiency data such as removal rate, by-products and water quality improvement, reaction kinetics data such as reaction rate and reaction mechanism, and scale data.

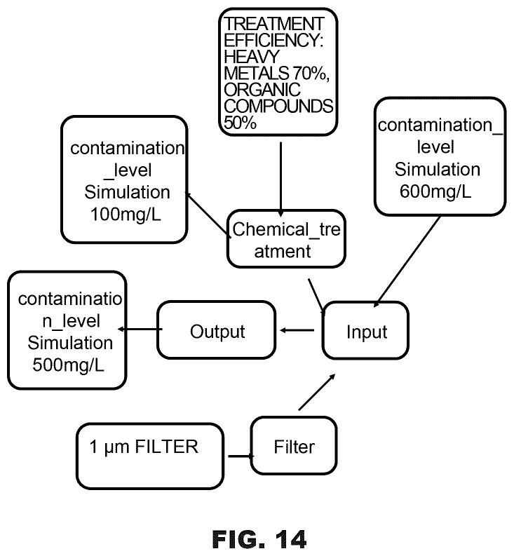

Here, it is assumed that the learning acceptance unit 22 has accepted a learning instruction. Next, for example, the graph forming unit 23 forms graph data from the simulation data contained in the training data in FIG. 13 through the above-described processing, using the knowledge data shown in FIG. 12. Note that there is no limitation on the algorithm for forming graph data. Next, the graph forming unit 23 temporarily accumulates the graph data of the simulation data in a buffer (not shown). An example of such graph data is shown in FIG. 14.

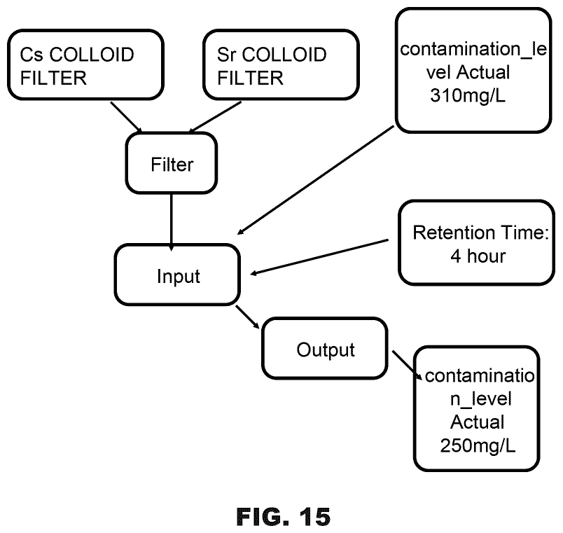

Also, for example, the graph forming unit 23 forms graph data from the actual machine data contained in the training data in FIG. 13 through the above-described processing, using the knowledge data shown in FIG. 12. Next, the graph forming unit 23 temporarily accumulates the graph data of the actual machine data in a buffer (not shown). An example of such graph data is shown in FIG. 15.

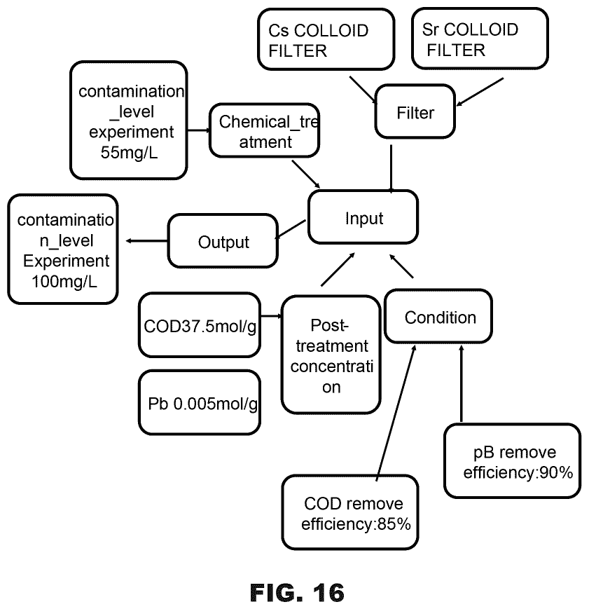

Also, for example, the graph forming unit 23 forms graph data from the experimental data contained in the training data in FIG. 13 through the above-described processing, using the knowledge data shown in FIG. 12. Next, the graph forming unit 23 temporarily accumulates the graph data of the experimental data in a buffer (not shown). An example of such graph data is shown in FIG. 16.

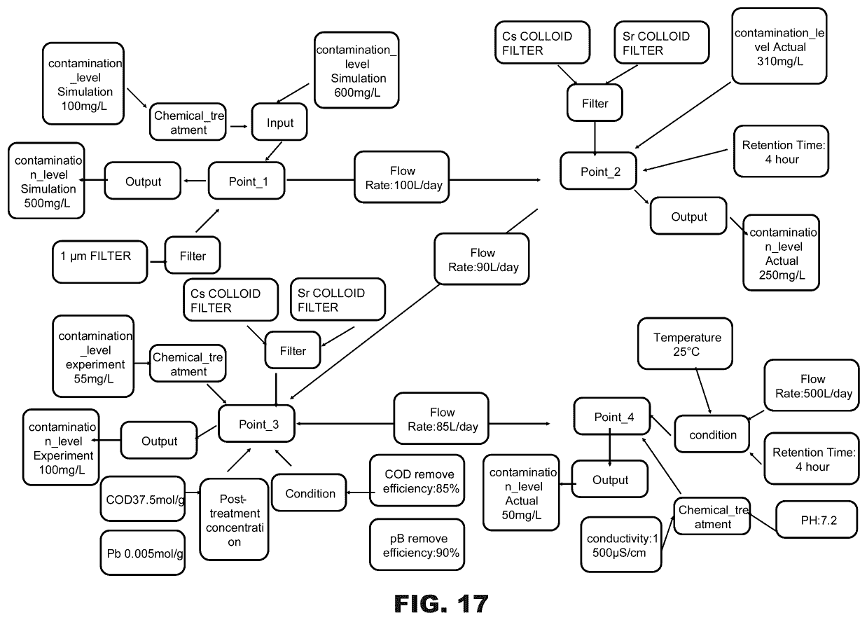

Next, for example, the graph forming unit 23 combines the pieces of graph data in FIGS. 14, 15, and 16, using the knowledge data shown in FIG. 12, to form one piece of graph data, and temporarily accumulates it in a buffer (not shown). An example of such graph data is shown in FIG. 17.

The graph forming unit 23 then performs the same processing as above on other pieces of training data to form a large number of pieces of training data (graph data) as shown in FIG. 17, and accumulates them.

Next, the learning unit 24 provides the large number of pieces of training data to a module that performs machine learning processing and executes the module to acquire a learning model. Note that the learning model here is a GNN. Next, the learning output unit 25 accumulates the learning model. Note that, for example, the learning output unit 25 accumulates the learning model in the model management unit 111 of the prediction apparatus 1.

### Specific Example 2

Now, for example, it is assumed that the acceptance unit 12 of the prediction apparatus 1 has accepted a prediction instruction that contains simulation data “Filter: 1 μm filter, Chemical Treatment: contamination_level: 100 mg/L, Treatment efficiency: heavy metals 70%, organic compounds 50%, Input contamination level: 600 mg/L, Output contamination_level: 500 mg/L, . . . ” and that is an instruction to predict and output actual machine data.

Next, the graph forming part 1311 of the prediction apparatus 1 forms graph data having the structure shown in FIG. 14 through the above-described algorithm.

Next, the prediction part 1312 provides the graph data and the learning model accumulated in the model management unit 111 in Specific Example 1 to a prediction module that performs machine learning prediction processing, and executes the prediction module. Next, the prediction part 1312 acquires graph data of the actual machine, having the structure shown in FIG. 15.

Next, the output unit 14 outputs the graph data and/or part of the information in the graph data, and/or information that has been converted into flat data from the graph data “<Actual machine data> Filter: Cs colloid filter, Sr colloid filter, input Retention Time: 4 hours, output contamination_level 250 mg/L . . . ”.

As described above, according to the present embodiment, it is possible to acquire, using one or more types of data sets selected from the group consisting of four types of data sets, namely, actual data, simulation result data, experimental result data, and calculation result data, one or more types of data sets other than the one or more types of data sets.

Also, according to the present embodiment, it is possible to acquire prediction results that include a data set of the same type as the accepted data, but which is a data set acquired at a point in time different from the given point in time of the accepted data.

Also, according to the present embodiment, a learning model that is a graph neural network (GNN) can be formed.

Furthermore, according to the present embodiment, highly accurate actual data can be acquired using the accepted simulation result data.

Furthermore, according to the present embodiment, highly accurate actual data can be acquired using simulation result data, which is the result of the accepted finite element analysis.

Note that the processing in the present embodiment may be realized using software. This software may be distributed through software downloading or the like. Also, this software may be recorded on a recording medium such as a CD-ROM and distributed. Note that the same applies to the other embodiments in the present description. Note that the software that realizes the prediction apparatus 1 according to the present embodiment is the program described below. That is to say, this program is a program that enables a computer to function as: an acceptance unit that accepts a group of explanatory variables constituted by one or more types of data sets selected from the group consisting of four types of data sets for a given subject, namely, an actual data set, a simulation result set, an experimental result set, and a calculation result set; a prediction unit that acquires a prediction result that is a group of objective variables corresponding to the group of explanatory variables by performing machine learning prediction processing, using a learning model created by performing learning processing using a group of training data including two or more types of data sets selected from the group consisting of an actual data set, a simulation result set, an experimental result set, and a calculation result set for the subject, and the group of explanatory variables accepted by the acceptance unit; and an output unit that outputs the prediction result acquired by the prediction unit.

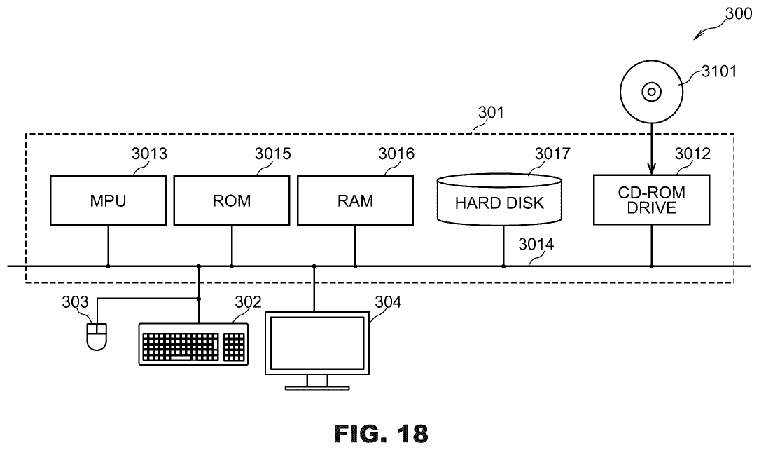

FIG. 18 is a block diagram of a computer system 300 that executes the program described in the present description to realize the prediction apparatus 1 and so on according to the various embodiments described above.

In FIG. 18, the computer system 300 includes a computer 301 that includes a CD-ROM drive, a keyboard 302, a mouse 303, and a monitor 304.

In FIG. 18, the computer 301 includes, in addition to the CD-ROM drive 3012, an MPU 3013, a bus 3014 that is connected to the CD-ROM drive 3012 and so on, a ROM 3015 for storing programs such as a boot-up program, a RAM 3016 that is connected to the MPU 3013 and is used to temporarily store application program instructions and provide a temporary storage space, and a hard disk 3017 for storing application programs, system programs, and data. Here, although not shown in the figure, the computer 301 may further include a network card that provides connection to a LAN.

The program that enables the computer system 300 to perform the functions of the prediction apparatus 1 and so on according to the above-described embodiments may be stored in the CD-ROM 3101, inserted into the CD-ROM drive 3012, and furthermore transferred to the hard disk 3017. Alternatively, the program may be transmitted to the computer 301 via a network (not shown) and stored on the hard disk 3017. The program is loaded into the RAM 3016 when the program is to be executed. The program may be directly loaded from the CD-ROM 3101 or the network.

The program does not necessarily have to include an operating system (OS), a third party program, or the like that enables the computer 301 to perform the functions of the prediction apparatus 1 and so on according to the embodiments described above. The program need only contain the part of the instruction that calls an appropriate function (module) in a controlled manner to achieve a desired result. How the computer system 300 works is well known and the detailed descriptions thereof will be omitted.

In the above-described program, the step of transmitting information, the step of receiving information and so on do not include processing performed by hardware, for example, processing performed by a modem or an interface card in the step of transmitting (processing that can only be performed by hardware).

There may be a single or multiple computers executing the above-described program. That is to say, centralized processing or distributed processing may be performed.

Also, in the above-described embodiments, each kind of processing may be realized as centralized processing that is performed by a single device, or distributed processing that is performed by multiple devices.

As a matter of course, the present invention is not limited to the above-described embodiments, and various changes are possible, and such variations are also included within the scope of the present invention.

### INDUSTRIAL APPLICABILITY

As described above, the prediction apparatus 1 according to the present invention has the effect of being able to obtain one or more types of data sets other than one or more types of data sets by using one or more types of data sets among the four types of data sets, namely, actual data, simulation result data, experimental result data, and calculation result data, and is useful as a server or the like that receives prediction instructions from a terminal device and returns prediction results.

### REFERENCE SIGNS LIST

1 Prediction Apparatus
2 Learning Apparatus
11 Storage Unit
12 Acceptance Unit
13 Processing Unit
14 Output Unit
21 Learning Storage Unit
22 Learning Acceptance Unit
23 Graph Forming Unit
24 Learning Unit
25 Learning Output Unit
111 Model Management Unit
112 Knowledge Management Unit
131 Prediction Unit
1311 Graph Forming Part
1312 Prediction Part

What is claimed is:

1. A prediction apparatus comprising:
an acceptance unit that accepts a group of explanatory variables constituted by one or more types of data sets selected from the group consisting of four types of data sets, namely, an actual data set, a simulation result set, an experimental result set, and a calculation result set for a given subject;
a prediction unit that acquires a prediction result that is a group of objective variables corresponding to the group of explanatory variables by performing machine learning prediction processing, using a learning model created by performing learning processing using a group of training data including two or more types of data sets selected from the group consisting of an actual data set, a simulation result set, an experimental result set, and a calculation result set for the given subject, and the group of explanatory variables accepted by the acceptance unit; and
an output unit that outputs the prediction result acquired by the prediction unit,
wherein the learning model is a graph neural network (GNN).

2. The prediction apparatus according to claim 1,
wherein the group of training data includes data sets of the same type acquired at two or more different points in time,
the group of explanatory variables accepted by the acceptance unit includes a data set for the given subject at a given point in time, and
the prediction unit performs machine learning prediction processing, using the learning model and the group of explanatory variables accepted by the acceptance unit, to acquire a prediction result including a data set that is of the same type as the data set accepted by the acceptance unit, acquired at a point in time different from the given point in time.

3. The prediction apparatus according to claim 1, further comprising:
a training data management unit in which two or more pieces of training data are stored, the two or more pieces of training data including two or more types of data sets selected from the group consisting of an actual data set, a simulation result set, an experimental result set, and a calculation result set for a given subject;
a knowledge management unit in which knowledge graph data is stored, the knowledge graph data containing: two or more pieces of knowledge node information and one or more pieces of knowledge edge information, the two or more pieces of knowledge node information being based on the two or more types of data sets, being two or more pieces of data that constitute graph data to be provided to a learning module that performs machine learning processing, and being two or more pieces of node information, and the one or more pieces of knowledge edge information being one or more pieces of edge information;
a graph forming unit that forms graph data to be provided to a learning module, using the knowledge graph data and the training data, for each of the two or more pieces of training data; and
a learning unit that provides the two or more pieces of graph data formed by the graph forming unit to the learning module, and executes the learning module to form a learning model,
wherein the learning model used by the prediction unit to perform machine learning prediction processing is the learning model formed by the learning unit.

4. The prediction apparatus according to claim 1, further comprising
a knowledge management unit in which knowledge graph data is stored, the knowledge graph data containing two or more pieces of knowledge node information and one or more pieces of knowledge edge information, the two or more pieces of knowledge node information being based on the two or more types of data sets, being two or more pieces of data that constitute graph data to be provided to a learning module that performs machine learning processing, and being two or more pieces of node information, and the one or more pieces of knowledge edge information being one or more pieces of edge information,
wherein the prediction unit includes:
a graph forming part that forms graph data, using the group of explanatory variables accepted by the acceptance unit and the two or more pieces of knowledge graph data; and
a prediction part that performs machine learning prediction processing, using the graph data formed by the graph forming part and the learning model, to acquire the prediction result.

5. The prediction apparatus according to claim 1,
wherein the two or more types of data sets include an actual data set and simulation result set, the group of explanatory variables includes a simulation result set, and the prediction result includes an actual data set.

6. The prediction apparatus according to claim 1,
wherein the two or more types of data sets include a simulation result set, and
the simulation result set is constituted by one or more results of a finite element analysis.

7. A prediction method realized using an acceptance unit, a prediction unit, and an output unit, the prediction method comprising:
an acceptance step in which the acceptance unit accepts a group of explanatory variables constituted by one or more types of data sets selected from the group consisting of four types of data sets for a given subject, namely, an actual data set, a simulation result set, an experimental result set, and a calculation result set;
a prediction step in which the prediction unit acquires a prediction result that is a group of objective variables corresponding to the group of explanatory variables by performing machine learning prediction processing, using a learning model created by performing learning processing using a group of training data including two or more types of data sets selected from the group consisting of an actual data set, a simulation result set, an experimental result set, and a calculation result set for the given subject, and the group of explanatory variables accepted by the acceptance unit; and
an output step in which the output unit outputs the prediction result acquired by the prediction unit,
wherein the learning model is a graph neural network (GNN).

8. A non-transitory computer-readable storage medium storing instructions that, when executed by one or more processors, cause the one or more processors to:
receive, via an acceptance unit, a group of explanatory variables constituted by one or more types of data sets selected from the group consisting of four types of data sets, namely, an actual data set, a simulation result set, an experimental result set, and a calculation result set for a given subject;
acquire, via a prediction unit, a prediction result that is a group of objective variables corresponding to the group of explanatory variables by performing machine learning prediction processing, using a learning model created by performing learning processing using a group of training data including two or more types of data sets selected from the group consisting of an actual data set, a simulation result set, an experimental result set, and a calculation result set for the given subject, and the group of explanatory variables accepted by the acceptance unit; and
output the prediction result via an output unit,
wherein the learning model is a graph neural network (GNN).
